(19) United States
(12) Patent Application Publication
(10) Pub. No.: US 2020/0101898 A1
(43) Pub. Date: Apr. 2, 2020

(54) TOW MODE HUD

(71) Applicant: Panasonic Automotive Systems Company of America, Division of Panasonic Corporation of North America, Peachtree City, GA (US)

(72) Inventors: EDO OMANOVIC, LIVONIA, MI (US); PATRICK O'CONNELL, NOVI, MI (US)

(73) Assignee: Panasonic Automotive Systems Company of America, Division of Panasonic Corporation of North America

(21) Appl. No.: 16/589,177

(22) Filed: Oct. 1, 2019

Related U.S. Application Data
(60) Provisional application No. 62/739,434, filed on Oct. 1, 2018.

(51) Int. Cl. B60R 1/00; H04N 5/225; G06K 9/00; B60R 1/12; B60K 35/00; B60Q 9/00

(52) U.S. Cl. CPC B60R 1/00; B60R 11/04; G06K 9/00798; G06K 9/00671; B60R 1/12; B60K 35/00; B60Q 9/00; B60R 2001/1253; B60R 2300/804; B60K 2370/1529; B60K 2370/167; B60K 2370/166; B60K 2370/164; B60K 2370/178; B60K 2370/31; H04N 5/2253

(57) ABSTRACT

A head up display arrangement is for a motor vehicle having a human driver. A camera is positioned and configured to capture images of an object being towed by the vehicle. A head up display module produces virtual images that are visible to the driver. The head up display module is operable in a conventional mode in which the virtual images are independent of the images captured by the camera, and in a tow mode in which the virtual images are dependent upon the images captured by the camera.

### CROSS-REFERENCED TO RELATED APPLICATIONS

This application claims benefit of U.S. Provisional Application No. 62/739,434 filed on Oct. 1, 2018, the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

When towing a trailer, the trailer tends to be wider than the vehicle itself so it is difficult to keep the trailer within a lane. Often times when the trailer leaves the lane, or has some other problem, the driver does not notice the trailer has any issues.

Currently the driver can only use the rearview mirrors to check if there are any issues with the trailer. This causes problems because the driver is no longer focused on the road ahead but instead on the side of the vehicle they are operating.

### SUMMARY

The present invention may utilize side view mirror camera inputs to provide the Head Up Display (HUD) with live footage of the blind spots in “tow” mode. During normal modes these video feeds from the side view mirror cameras are not utilized. However, once the vehicle is in tow mode the HUD displays the live feeds from the side view mirror cameras on either end of the virtual image. The HUD may also provide information to the driver which is needed for towing, such as torque, wind speed for trailer sway, and so on. In another embodiment, instead of the live feed being displayed on either end of the virtual image, a graphic is displayed that lets the driver know whether the trailer is properly in the lane or whether the driver needs to take corrective action.

The invention may enable the driver to keep their eyes on the road while still being informed of whether the trailer is in lane or not and whether corrective action needs to be taken. In case of any damage to the trailer such as a flat tire, the driver may be notified of the trailer swaying into another lane so that the driver may slow down or stop to fix the issue.

In one embodiment, the invention comprises a head up display arrangement for a motor vehicle having a human driver. A camera is positioned and configured to capture images of an object being towed by the vehicle. A head up display module produces virtual images that are visible to the driver. The head up display module is operable in a conventional mode in which the virtual images are independent of the images captured by the camera, and in a tow mode in which the virtual images are dependent upon the images captured by the camera.

In another embodiment, the invention comprises a head up display method for a motor vehicle having a driver images are captured of an object being towed by the vehicle. A head up display is used to produce virtual images that are visible to the driver. Operation of the head up display module is switched between a conventional mode in which the virtual images are independent of the images captured by the camera and a tow mode in which the virtual images are dependent upon the images captured by the camera.

In yet another embodiment, the invention comprises a head up display arrangement for a motor vehicle having a human driver. A camera is positioned and configured to capture images of an object being towed by the vehicle on a road. A head up display module produces virtual images that are visible to the driver. The head up display module is operable in a tow mode in which the virtual images are dependent upon the images captured by the camera. Sensing means detects that the towed object has crossed a line marker on the road and, in response to the detecting, causes the head up display module to provide a visual warning to the driver that the towed object has crossed the line marker on the road.

An advantage of the present invention is that it enables a driver to monitor an object he is towing without taking his eyes off of the road.

### BRIEF DESCRIPTION OF THE DRAWINGS

A better understanding of the present invention will be had upon reference to the following description in conjunction with the accompanying drawings.

FIG. 1 is a schematic overhead view of one embodiment of a truck with a HUD traveling in a prior art mode of operation.

FIG. 2 is a schematic overhead view of the truck of FIG. 1 towing a trailer with the truck's HUD in a tow mode of operation of the present invention.

FIG. 3 is a plan view of one embodiment of an automotive dashboard and head up display including the tow mode feature of the present invention.

FIG. 4 is a block diagram of another embodiment of an automotive head up display tow mode arrangement of the present invention, such as for use in the truck of FIG. 2.

FIG. 5 is a flow chart of one embodiment of a head up display method of the present invention for a motor vehicle having a driver.

### DETAILED DESCRIPTION OF THE PREFERRED EMBODIMENTS

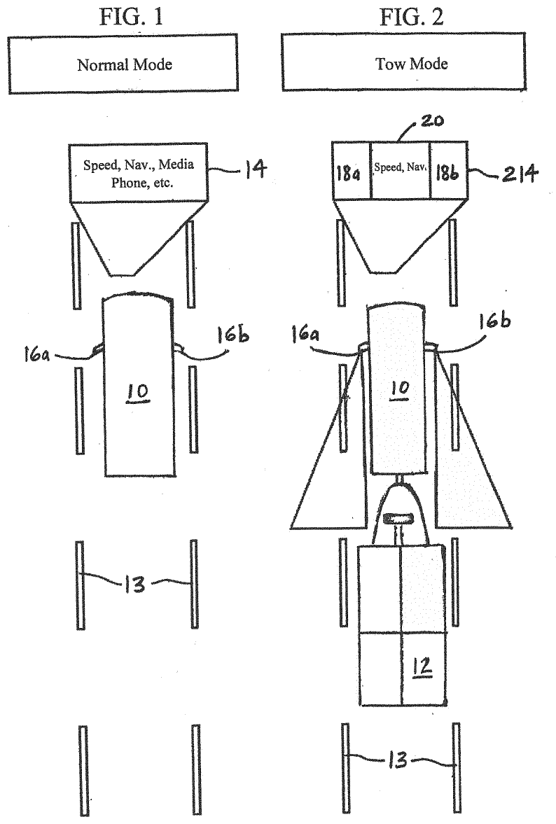

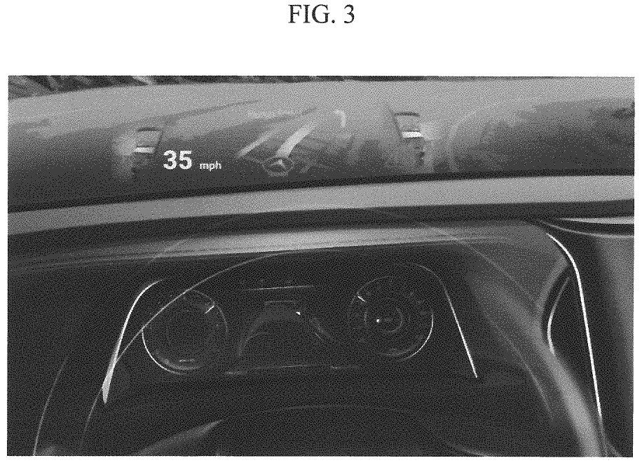

FIGS. 1-2 illustrate two scenarios, one scenario (FIG. 1) with a truck 10 in a known normal mode of operation of the prior art while not towing, and the other scenario (FIG. 2) with truck 10 in a HUD tow mode of operation of the present invention while towing a trailer 12 on a road having lane markers 13. In the FIG. 1 scenario, the HUD of truck 10 presents a virtual image 14 including information normally presented by a HUD, such as vehicle speed, navigation information, media information, telephone information, etc. In contrast, in the FIG. 2 scenario, images captured by sideview cameras 16a-b are presented on opposite lateral sides of virtual image 214 in areas 18a-b, respectively. A central portion 20 of virtual image 214 includes an edited or reduced version of the information presented in virtual image 14. For example, central portion 20 of virtual image 214 may include only vehicle speed information and navigation information. That is, in the tow mode, the virtual images may include a subset of types of information that are included in the virtual images in the conventional mode. Thus, some unnecessary information may be eliminated from the virtual image While Tow Mode is active so that there can be additional space in the virtual image for the live camera feed or indicators which tell the driver what the trailer behind them is doing.

A tow mode HUD Arrangement (not shown) of the present invention disposed within truck 10 may enable the driver of truck 10 to turn ON/OFF the tow mode feature in their HUD, Video processing within the HUD may also be used to analyze the images captured by cameras 16a-b and determine therefrom whether truck 10 is towing something, in which case the tow mode feature may be automatically turned ON. Another type of sensor, such as a proximity sensor for example, may also be used to detect whether truck 10 is towing something, in which case the tow mode feature may be automatically turned ON. Turning on the tow mode feature may automatically add to the virtual image the video feeds from camera 16a-b in areas 18a-b, respectively.

From the side mounted cameras 16a-b, video may be fed to the HUD which may provide the driver with an image of what is behind truck 10 and approximately aligned with the lateral sides of truck 10. Image processing may be performed to either provide the entire images to the driver or only that portion of the images that includes the towed object and lane markers on the road.

FIG. 3 illustrates one embodiment of an automotive dashboard and head up display including the tow mode feature of the present invention. Shown in the windshield is the HUD virtual image while the driver is towing a boat. It can be seen that the trailer has drifted slightly to the right and the driver is being notified that the trailer has crossed over the lane marker. This will indicate to the driver to take corrective action and move the vehicle towards the left slightly. More particularly, the lane marker that has been crossed in the righthand side of the virtual image is presented in the color red. Next to the red lane marker is also a red triangle with a red exclamation point inside to draw the driver's attention to the trailer having crossed the lane marker.

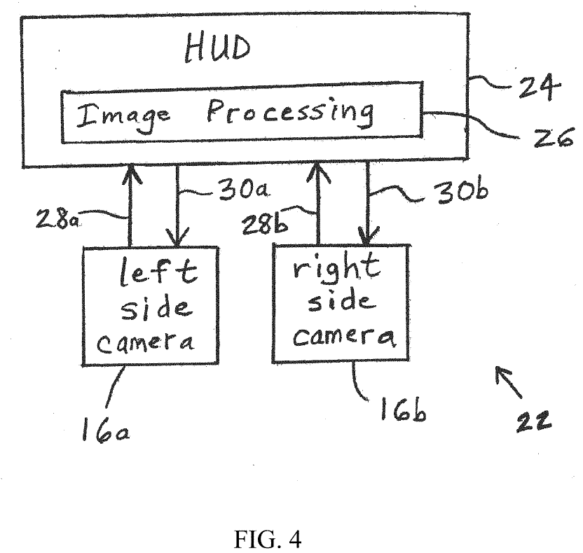

FIG. 4 illustrates one embodiment of an automotive head up display with tow mode arrangement 22 of the present invention, such as for use in truck 10. Arrangement 22 includes left side camera 16a, right side camera 16b, and HUD module 24. HUD module 24 includes an image processing block 26.

During use, cameras 16a-b may provide respective video signals 28a-b to HUD module 24, and HUD module 24 may provide electrical power to camera 16a-b, as indicated at 30a-b, respectively. In response to determining that truck 10 is towing trailer 12, HUD module 24 may switch from the conventional mode to the HUD tow mode in which images captured by cameras 16a-b are presented to the truck driver as virtual images in areas 18a-b.

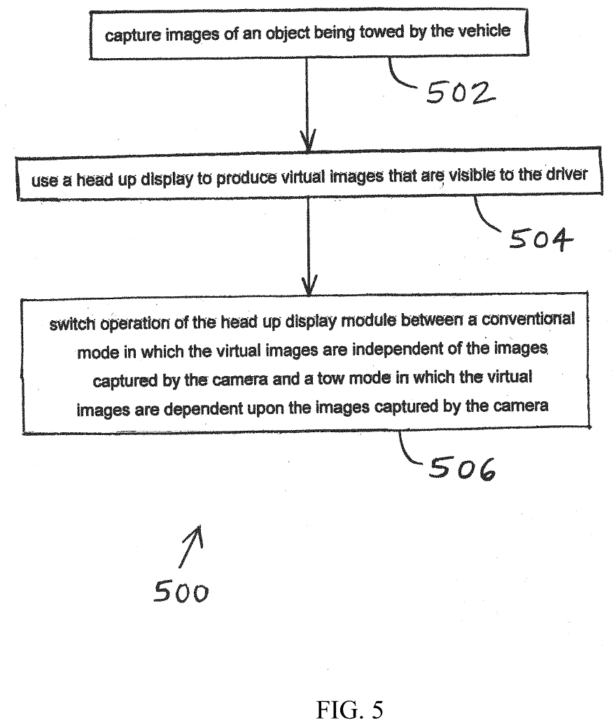

FIG. 5 illustrates one embodiment of a head up display method of the present invention for a motor vehicle having a driver. In a first step 502, images of an object being towed by the vehicle are captured. For example, cameras 16a-b may capture images of trailer 12.

In a next step 504, a head up display is used to produce virtual images that are visible to the driver. For example, HUD module 24 may produce virtual images such as those in FIG. 3 which are visible to the driver as he looks at the windshield.

In a final step 506, operation of the head up display module is switched between a conventional mode in which the virtual images are independent of the images captured by the camera and a tow mode in which the virtual images are dependent upon the images captured by the camera. For example, operation of head up display module 24 may be switched between a conventional mode in which the virtual images are independent of the images captured by cameras 16a-b and a tow mode in which the virtual images are dependent upon the images captured by cameras 16a-b. In the conventional mode, the virtual images may include vehicle speed and other information about vehicle operation. In the tow mode, the virtual images may include images of trailer 12 captured by cameras 16a-b.

The side view cameras have been described herein as being attached to or adjacent the side view mirrors. However, it is also within the scope of the invention for side view cameras to be mounted at the rear of the vehicle to provide more accurate information to the driver.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A head up display arrangement for a motor vehicle having a human driver, comprising:
a camera positioned and configured to capture images of an object being towed by the vehicle; and
a head up display module configured to produce virtual images that are visible to the driver, the head up display module being operable in a conventional mode in which the virtual images are independent of the images captured by the camera and in a tow mode in which the virtual images are dependent upon the images captured by the camera.

2. The head up display arrangement of claim 1 wherein the camera is mounted on or adjacent to an exterior side view mirror of the vehicle.

3. The head up display arrangement of claim 1 wherein the camera comprises a first camera mounted on a first lateral side of the vehicle, the arrangement further comprising a second camera mounted on a second lateral side of the vehicle, the virtual images being dependent upon the images captured by each of the first camera and the second camera.

4. The head up display arrangement of claim 3 wherein, when in the tow mode, the virtual images include a left lateral end area based on the images captured by the first camera and a right lateral end area based on the images captured by the second camera.

5. The head up display arrangement of claim 1 wherein the head up display module is configured to:
process the images captured by the camera to determine that the object being towed by the vehicle has crossed a lane marker on a road; and
in response to the determining that the object being towed by the vehicle has crossed the lane marker on the road, present a visible warning to the driver that the object being towed by the vehicle has crossed the lane marker on the road.

6. The head up display arrangement of claim 5 wherein the visible warning to the driver comprises highlighting a portion of the virtual image in a predetermined color.

7. The head up display arrangement of claim 1 wherein, in the tow mode, the virtual images include a subset of types of information that are included in the virtual images in the conventional mode.

8. A head up display method for a motor vehicle having a driver, said method comprising:
capturing images of an object being towed by the vehicle;
using a head up display to produce virtual images that are visible to the driver; and
switching operation of the head up display module between a conventional mode in which the virtual images are independent of the images captured by the camera and a tow mode in which the virtual images are dependent upon the images captured by the camera.

9. The method of claim 8 wherein the images are captured by a camera mounted on or adjacent to an exterior side view mirror of the vehicle.

10. The method of claim 9 wherein the camera comprises a first camera mounted on a first lateral side of the vehicle, the virtual images being dependent upon the images captured by the first camera and upon images captured by a second camera mounted on a second lateral side of the vehicle that is opposite the first lateral side of the vehicle.

11. The method of claim 10 wherein, when in the tow mode, the virtual images include a left lateral end area based on the images captured by the first camera and a right lateral end area based on the images captured by the second camera.

12. The method of claim 8 further comprising:
processing the captured images to determine that the object being towed by the vehicle has crossed a lane marker on a road; and
in response to the determining that the object being towed by the vehicle has crossed the lane marker on the road, presenting a visible warning to the driver that the object being towed by the vehicle has crossed the lane marker on the road.

13. The method of claim 12 wherein the visible warning to the driver comprises highlighting a portion of the virtual image in a predetermined color.

14. The method of claim 8 wherein, in the tow mode, the virtual images include a subset of types of information that are included in the virtual images in the conventional mode.

15. A head up display arrangement for a motor vehicle having a human driver, comprising:
a camera positioned and configured to capture images of an object being towed by the vehicle on a road;
a head up display module configured to produce virtual images that are visible to the driver, the head up display module being operable in a tow mode in which the virtual images are dependent upon the images captured by the camera; and
means for sensing that the towed object has crossed a line marker on the road and, in response to the sensing, causing the head up display module to provide a visual warning to the driver that the towed object has crossed a line marker on the road.

16. The head up display arrangement of claim. 15 wherein the head up display module is configured to also produce the virtual images in a conventional mode in which the virtual images are independent of the images captured by the camera.

17. The head up display arrangement of claim 16 wherein, in the tow mode, the virtual images include a subset of types of information that are included in the virtual images in the conventional mode.

18. The head up display arrangement of claim 15 wherein the camera is mounted on or adjacent to an exterior side view mirror of the vehicle.

19. The head up display arrangement of claim 15 wherein the camera comprises a first camera mounted on a first lateral side of the vehicle, the arrangement further comprising a second camera mounted on a second lateral side of the vehicle, the virtual images being dependent upon the images captured by each of the first camera and the second camera.

20. The head up display arrangement of claim 19 wherein, when in the tow mode, the virtual images include a left lateral end area based on the images captured by the first camera and a right lateral end area based on the images captured by the second camera.
